(19) United States
(12) Patent Application Publication
(10) Pub. No.: US 2012/0119946 A1
(43) Pub. Date: May 17, 2012

(54) SYSTEM AND METHOD FOR TESTING PERFORMANCE OF TRANSPONDER

(75) Inventors: Jin Ho JO, Daejeon (KR); Moon Hee You, Daejeon (KR); Seong Pal Lee, Daejeon (KR); Jae Hoon Kim, Daejeon (KR)

(73) Assignee: Electronics and Telecommunications Research Institute, Daejeon (KR)

(21) Appl. No.: 13/296,860

(22) Filed: Nov. 15, 2011

(30) Foreign Application Priority Data
Nov. 16, 2010 (KR) 10-2010-0113995

(51) Int. Cl. H04B 7/185

(52) U.S. Cl. 342/353

(57) ABSTRACT

Disclosed is a satellite performance monitoring system. The satellite performance monitoring system may include a satellite communication controlling apparatus that is installed outdoors to transmit a test signal for measuring a performance of a satellite transponder to the satellite transponder and thereby receive a test response signal from the satellite transponder, and to transmit a reference signal to the satellite transponder and thereby receive a reference response signal from the satellite transponder; and a satellite performance monitoring apparatus that is installed indoors to generate the test signal and the reference signal, to generate a frequency response characteristic with respect to the satellite transponder using the test response signal, to compute a signal change amount occurring due to a weather condition using the reference signal and the reference response signal, and to apply the computed signal change amount to the frequency response characteristic.

### CROSS-REFERENCE TO RELATED APPLICATION

This application claims the priority benefit of Korean Patent Application No. 10-2010-0113995, filed on Nov. 16, 2010, in the Korean Intellectual Property Office, the disclosure of which is incorporated herein by reference.

### BACKGROUND

1. Field of the Invention

Embodiments of the present invention relate to a satellite performance monitoring system and method for measuring a performance of a satellite transponder regardless of a weather condition.

2. Description of the Related Art

A satellite transponder corresponds to a communication device that is mounted to a communication satellite, a broadcasting satellite, and the like, to amplify a signal received from an earth station, and to retransmit the amplified signal to the earth station. When the satellite transponder is mounted within a satellite orbit, the earth station may perform a test for measuring a performance of the satellite transponder. Such test is referred to as an in orbit test (IOT).

Currently, frequencies available for a communication broadcasting satellite have been gradually exhausted, whereas an amount of multimedia data transmission has been increasing. Accordingly, there has been a demand for a wide frequency band. It is difficult to additionally assign a frequency to an existing frequency band. Thus, as an alternative scheme, Ka band that is a new frequency band has been developed.

Frequencies included in Ka band may not be frequently used for a satellite service being provided, and may be suitable for a next generation satellite broadcasting service, for example, a high definition television/three-dimensional TV (HDTV/3DTV) satellite broadcasting service or a large satellite communication service having a wide frequency band.

Frequencies included in Ka band may be affected by a weather condition, particularly, rain to change a test signal for measuring a performance of the satellite transponder. However, the earth station may be unaware of whether a change in the test signal has occurred due to the performance of the satellite transponder or due to the weather condition.

### SUMMARY

An aspect of the present invention provides a satellite performance monitoring system and method that may compute a signal change amount occurring due to a weather condition using a reference signal and a reference response signal, and may compensate for a frequency response characteristic with respect to a satellite transponder using the computed signal change amount, thereby measuring a performance of the satellite transponder regardless of the weather condition.

According to an aspect of the present invention, there is provided a satellite performance monitoring system for measuring a performance of a satellite transponder, the system including: a satellite communication controlling apparatus that is installed outdoors to transmit a test signal for measuring the performance of the satellite transponder to the satellite transponder and thereby receive a test response signal from the satellite transponder, and to transmit a reference signal to the satellite transponder and thereby receive a reference response signal from the satellite transponder; and a satellite performance monitoring apparatus that is installed indoors to generate the test signal and the reference signal, to generate a frequency response characteristic with respect to the satellite transponder using the test response signal, to compute a signal change amount occurring due to a weather condition using the reference signal and the reference response signal, and to apply the computed signal change amount to the frequency response characteristic.

According to another aspect of the present invention, there is provided a satellite performance monitoring method for measuring a performance of a satellite transponder, the method including: transmitting, to the satellite transponder, a test signal for measuring the performance of the satellite transponder; transmitting a reference signal to the satellite transponder; generating a frequency response characteristic with respect to the satellite transponder using a test response signal when the test response signal is received from the satellite transponder; computing a signal change amount occurring due to a weather condition using the reference signal and a reference response signal when the reference response signal is received from the satellite transponder; and applying the computed signal change amount to the frequency response characteristic.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a satellite performance monitoring system for measuring a performance of a satellite transponder according to an embodiment of the present invention;

FIG. 2 is a block diagram illustrating a configuration of a satellite performance monitoring system according to an embodiment of the present invention;

FIG. 3 and FIG. 4 are graphs showing a frequency response characteristic generated by a satellite transponder according to an embodiment of the present invention;

FIG. 5 is a graph showing a signal change amount occurring due to a weather condition according to an embodiment of the present invention;

FIG. 6 is a graph showing a method of applying a reference signal change amount to a frequency response characteristic according to an embodiment of the present invention; and

FIG. 7 is a flowchart illustrating a satellite performance monitoring method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

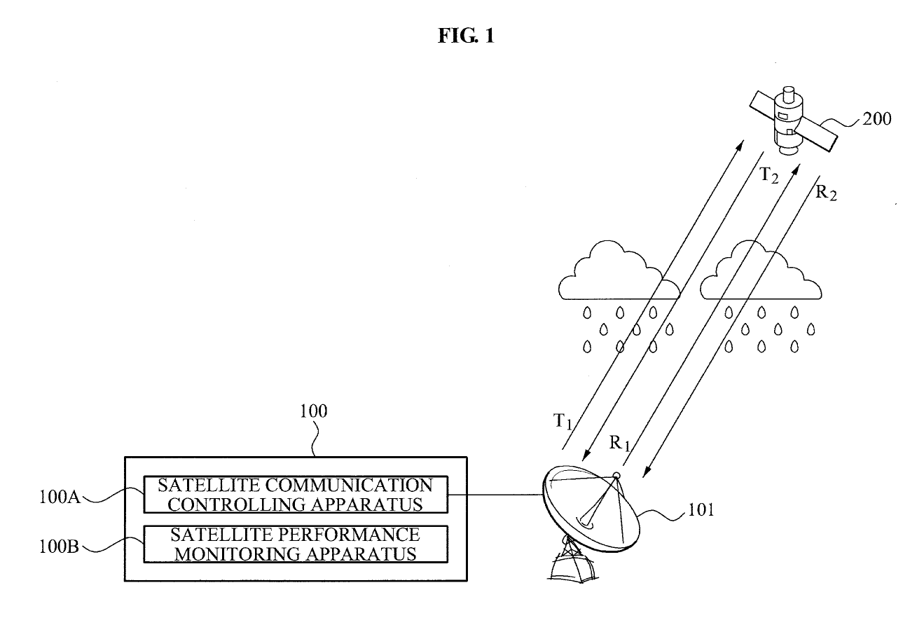

FIG. 1 is a diagram illustrating a satellite performance monitoring system 100 for measuring a performance of a satellite transponder according to an embodiment of the present invention.

Referring to FIG. 1, when a satellite transponder 200 is mounted to a communication satellite or an artificial satellite, the satellite performance monitoring system 100 may measure a performance of the satellite transponder 200 to verify whether the satellite transponder 200 may exhibit the same performance as on the ground. That is, the satellite performance monitoring system 100 may be a type of in orbit testing/communication system monitoring (IOT/CSM) equipment.

The satellite performance monitoring system 100 may include a satellite communication controlling apparatus 100A that is connected to an antenna 101, and a satellite performance monitoring apparatus 100B.

The satellite communication controlling apparatus 100A may be installed outdoors to control signal transmission and reception with the satellite transponder 200.

The satellite performance monitoring apparatus 100B may be installed indoors to generate a test signal T₁ and a reference signal R₁. The test signal T₁ may be a signal for measuring the performance of the satellite transponder 200, and the reference signal R₁ may be a signal for computing a signal change amount occurring due to a weather condition.

The satellite performance monitoring apparatus 100B may repeatedly generate the test signal T₁ at first frequency intervals over the whole channel bandwidth of the satellite transponder 200. Also, the satellite performance monitoring apparatus 100B may repeatedly generate the reference signal R₁ by adding the reference signal R₁ within the first frequency time interval.

The satellite performance monitoring apparatus 100B may adjust a magnitude of the reference signal R₁ to be less than a magnitude of the test signal T₁. This is to prevent an error from occurring when measuring the performance of the satellite transponder 200 due to the affect of the reference signal R₁ against the test signal T₁.

The satellite communication controlling apparatus 100A may transmit the test signal T₁ and the reference signal R₁ to the satellite transponder 200. When the test signal T₁ is received, the satellite transponder 200 may amplify the test signal T₁ and thereby generate a test response signal T₂. The satellite transponder 200 may transmit the test response signal T₂ to the satellite performance monitoring system 100.

Also, when the reference signal R₁ is received, the satellite transponder 200 may amplify the reference signal R₁ and thereby generate a reference response signal R₂. The satellite transponder 200 may transmit the reference response signal R₂ to the satellite communication controlling apparatus 100A.

The satellite performance monitoring apparatus 100B may receive the test response signal T₂ and the reference response signal R₂ via the antenna 101.

The satellite performance monitoring apparatus 100B may generate a frequency response characteristic with respect to the satellite transponder using the test response signal T₂. The satellite performance monitoring apparatus 100B may generate the frequency response characteristic using a graph in which test response signals T₂ are at first frequency intervals.

When a consistent frequency response characteristic is generated based on a center frequency of the whole channel bandwidth using the test response signal T₂ that is received from the satellite transponder 200, the consistent frequency response characteristic may indicate that there was no change in a signal due to the weather condition.

On the contrary, when an inconsistent frequency response characteristic is generated based on the center frequency, the inconsistent frequency response characteristic may indicate that there was a change in a signal due to the weather condition. For example, the inconsistent frequency response characteristic may indicate that there was a change in the test signal T1 or the test response signal T₂ due to wind, rain, cloud, snow, lighting, and the like, in the air.

When the test signal T1 or the test response signal T₂ was changed due to the weather condition, it may be difficult to accurately measure the performance of the satellite transponder 200 even though the frequency response characteristic is used. Accordingly, the satellite performance monitoring apparatus 100B may compute a signal change amount occurring due to the weather condition using the reference signal R₁ and the reference response signal R₂, and may apply the computed signal change amount to the frequency response characteristic.

Specifically, the satellite performance monitoring system 100 may compute the signal change amount occurring due to the weather condition by subtracting the reference signal R₁, transmitted to the satellite transponder 200 at first time intervals, from the reference response signal R₂ that is received from the satellite transponder 200. The satellite performance monitoring system 100 may compensate for a change in a signal according to the weather condition by applying the computed signal change amount to the frequency response characteristic. Accordingly, the satellite performance monitoring system 100 may accurately measure the performance of the satellite transponder 200 using the compensated frequency response characteristic, regardless of the weather condition.

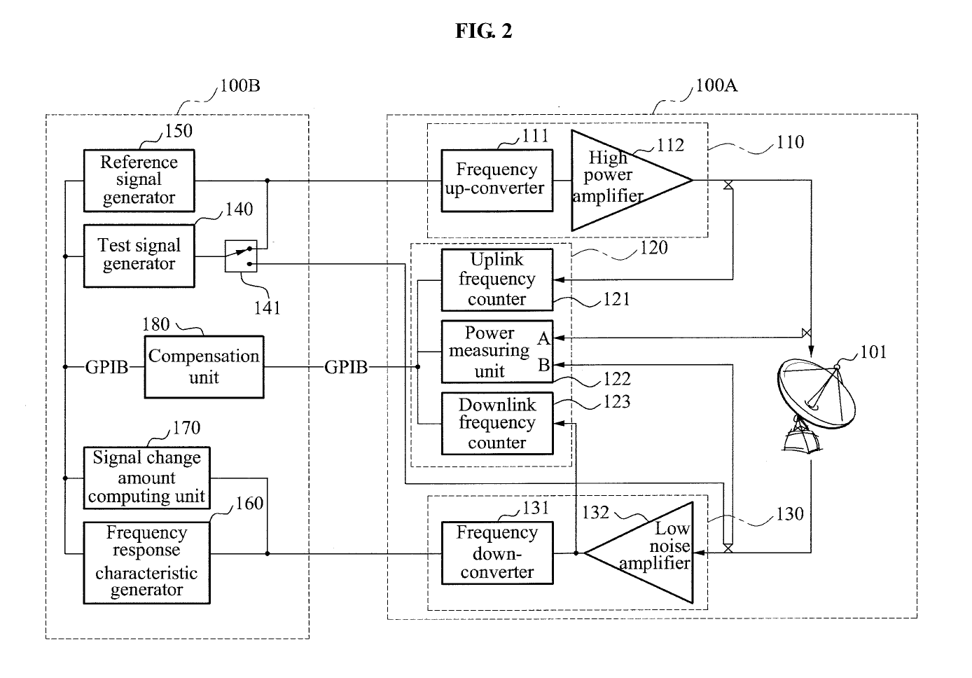

FIG. 2 is a block diagram illustrating a configuration of the satellite performance monitoring system 100 according to an embodiment of the present invention. Referring to FIG. 2, the satellite performance monitoring system 100 may include the satellite communication controlling apparatus 100A and the satellite performance monitoring apparatus 100B.

The satellite performance monitoring apparatus 100B may generate a test signal T₁ for measuring a performance of the satellite transponder 200 and a reference signal R₁ for computing a signal change amount occurring due to a weather condition.

The satellite communication controlling apparatus 100A may transmit the test signal T₁ and the reference signal R₁ to the satellite transponder 200, and may transfer, to the satellite performance monitoring apparatus 100B, a test response signal T₂ and a reference response signal R₂ that are received from the satellite transponder 200.

The satellite communication controlling apparatus 100A may be installed outdoors as an apparatus to control signal transmission and reception with the satellite transponder 200 and may process the test signal T₁, the test response signal T₂, the reference signal R_{I}, and the reference response signal R₂ using Ka band. The satellite performance monitoring apparatus 100B may be installed indoors to process the test signal T₁, the test response signal T₂, the reference signal R₁, and the reference response signal R₂ using L band. This is to perform processing using an L band signal having a relatively less loss or distortion in a radio frequency (RF) cable (not shown) that connects the satellite communication controlling apparatus 100A and the satellite performance monitoring apparatus 100B since loss or distortion of a Ka band signal is great in the RF cable.

Hereinafter, an operation of the satellite communication controlling apparatus 100A and the satellite performance monitoring apparatus 100B will be further described.

The satellite communication controlling apparatus 100A may include the antenna 101, a first signal processing unit 110, a signal measuring unit 120, and a second signal processing unit 130.

The antenna 101 may transmit and receive a signal to and from the satellite transponder 200.

The first signal processing unit 110 may receive and process the test signal T₁ and the reference signal R₁ that are generated by the satellite performance monitoring apparatus 100B. For example, the first signal processing unit 110 may include a frequency up-converter 111 and a high power amplifier 112.

The frequency up-converter 111 may up convert the test signal T₁ and the reference signal R₁ from L band to Ka band. The test signal T₁ and the reference signal R₁ that are generated by the satellite performance monitoring apparatus 100B may be a frequency signal corresponding to L band. A process of up converting the test signal T₁ and the reference signal R₁ from L band to Ka band may be used to transmit the test signal T₁ and the reference signal R₁ to the satellite transponder 200 using a frequency of Ka band.

The high power amplifier 112 may amplify the test signal T₁ and the reference signal R₁ that are up converted to Ka band by the frequency up-converter 111.

The antenna 101 may transmit the amplified test signal T₁ and reference signal R₁ to the satellite transponder 200. When the satellite transponder 200 receives the test signal T₁ and the reference signal R_{I}, the satellite transponder 200 may generate the test response signal T₂ and the reference response signal R₂ by amplifying the test signal T₁ and the reference signal R₁, and may transmit the test response signal T₂ and the reference response signal R₂ to the satellite performance monitoring system 100. Accordingly, the antenna 101 may receive the test response signal T₂ and the reference response signal R₂ from the satellite transponder 200.

The second signal processing unit 130 may process the received test response signal T₂ and reference response signal R₂. The second signal processing unit 130 may include a frequency down-converter 131 and a low noise amplifier 132.

The low noise amplifier 132 may amplify the test response signal T₂ and the reference response signal R₂ that are received via the antenna 101.

The frequency down-converter 131 may down convert the amplified test response signal T₂ and reference response signal R₂ to L band. Prior to transmitting, to the satellite performance monitoring apparatus 100B, the test response signal T₂ and the reference response signal R₂ of Ka band that are generated by the satellite transponder 200, a process of down converting the test response signal T₂ and the reference response signal R₂ from Ka band to L band may be used.

The signal measuring unit 120 may measure a signal characteristic with respect to the test signal T₁, the reference signal R₁, the test response signal T₂, and the reference response signal R₂, and may include an uplink frequency counter 121, a power measuring unit 122, and a downlink frequency counter 123.

The uplink frequency counter 121 may count the number of frequencies that are up converted by the frequency up-converter 111 of the first signal processing unit 110.

The power measuring unit 122 may measure power of the satellite communication controlling apparatus 100A based on an operation of transmitting and receiving one of the test signal T₁, the reference signal R₁, the test response signal T₂, and the reference response signal R₂.

The downlink frequency counter 123 may count the number of frequencies that are down converted by the frequency down-converter 131 of the second signal processing unit 130.

The satellite performance monitoring apparatus 100B may include a test signal generator 140, a reference signal generator 150, a frequency response characteristic generator 160, a signal change amount computing unit 170, and a compensation unit 180.

The test signal generator 140 may repeatedly generate the test signal T₁ for measuring the performance of the satellite transponder 200 at first frequency intervals over the whole channel bandwidth of the satellite transponder 200.

The reference signal generator 150 may generate the reference signal R₁. Here, the reference signal generator 150 may add the reference signal R₁ within the first frequency interval and thereby repeatedly generate the reference signal R₁ over the whole channel bandwidth of the satellite transponder 200. This is to prevent interference against the test signal T₁.

Also, the reference signal generator 150 may adjust a magnitude of the reference signal R₁ to be less than a magnitude of the test signal T₁. This is to prevent an error from occurring in measuring the performance of the satellite transponder 200 due to the magnitude of the reference signal R₁.

When the test response signal T₂ of L band is received from the satellite communication controlling apparatus 100A, the frequency response characteristic generator 160 may generate a frequency response characteristic using the test response signal T₂. A plurality of test response signals T₂ may be generated at first frequency intervals, and the frequency response characteristic may be generated using a graph in which the plurality of test response signals T₂ are arranged at first frequency intervals.

When the frequency response characteristic is consistent based on a center frequency of the whole channel bandwidth, it may indicate that there was no change in a signal occurring due to a weather condition. On the contrary, when the frequency response characteristic is inconsistent based on the center frequency, it may indicate that there was a change in a signal occurring due to the weather condition.

When the reference response signal R₂ of L band is received from the satellite communication controlling apparatus 100A, the signal change amount computing unit 170 may compute a signal change amount by subtracting the reference signal R₁ from the reference response signal R₂.

The compensation unit 180 may compensate for the change in the signal occurring due to the weather condition by applying the computed signal change amount to the frequency response characteristic. Through compensation by a signal result value corresponding to a portion attenuated by the weather condition, the frequency response characteristic of the satellite transponder 200 may be accurately measured.

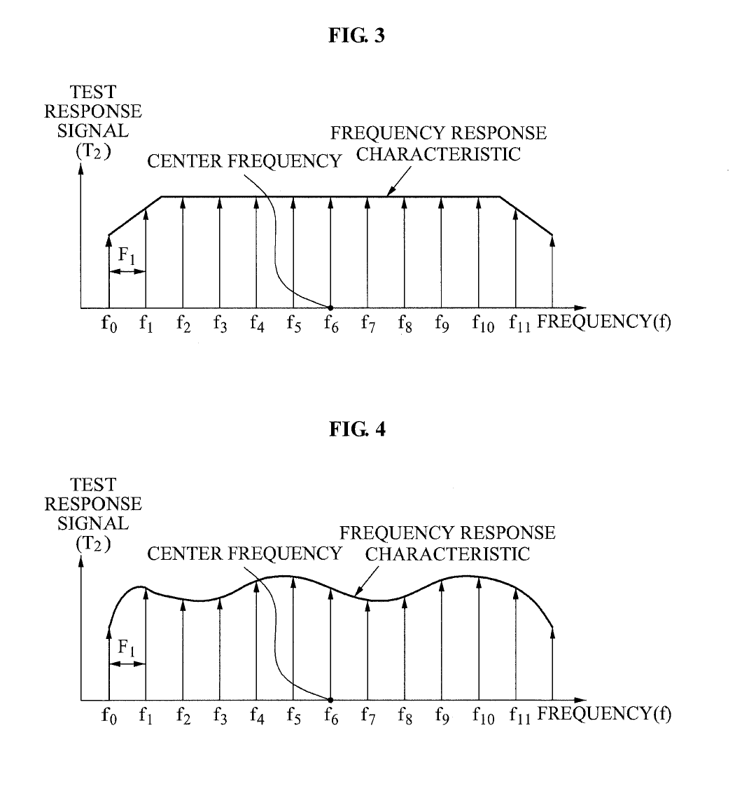

FIG. 3 and FIG. 4 are graphs showing a frequency response characteristic generated by the satellite transponder 200 according to an embodiment of the present invention. FIG. 3 is a graph showing a frequency response characteristic of the satellite transponder 200 that is not affected by a weather condition.

Referring to the graph of FIG. 3, the frequency response characteristic may be generated by repeatedly generating test signals T₁ at first frequency intervals F₁, transmitting the test signals T₁ to the satellite transponder 200 in a first frequency f₀ to a twelfth frequency f₁₁, receiving a test response signal T₂ corresponding to each of the test signals T₁ from the satellite transponder 200, and arranging the test response signals T₂ with respect to the respective first frequency f₀ to the twelfth frequency f₁₁.

The frequency response characteristic of FIG. 3 is consistent based on a center frequency of the whole channel bandwidth of the satellite transponder 200 and thus, it can be known that a signal change according to the weather condition has not occurred. When the signal change according to the weather condition occurs, signals may vary differently over time and thus, the frequency response characteristic may appear inconsistently based on the center frequency. It will be further described with reference to FIG. 4.

FIG. 4 is a graph showing a frequency response characteristic of the satellite transponder 200 that is affected by a weather condition.

Referring to the graph of FIG. 4, the frequency response characteristic may be generated by repeatedly generating test signals T₁ at first frequency intervals F₁, transmitting the test signals T₁ to the satellite transponder 200 in a first frequency f₀ to a twelfth frequency f₁₁, receiving a test response signal T₂ corresponding to each of the test signals T₁ from the satellite transponder 200, and arranging the test response signals T₂ with respect to the respective first frequency f₀ to the twelfth frequency f₁₁.

The frequency response characteristic of FIG. 4 is inconsistent based on a center frequency of the whole channel bandwidth of the satellite transponder 200 and thus, it can be known that a signal change according to the weather condition has occurred. The frequency response characteristic includes the change in the signal occurring due to the weather condition and thus, may not accurately measure the performance of the satellite transponder 200. Accordingly, it is possible to compensate for the frequency response characteristic using a reference signal R₁ and a reference response signal R₂.

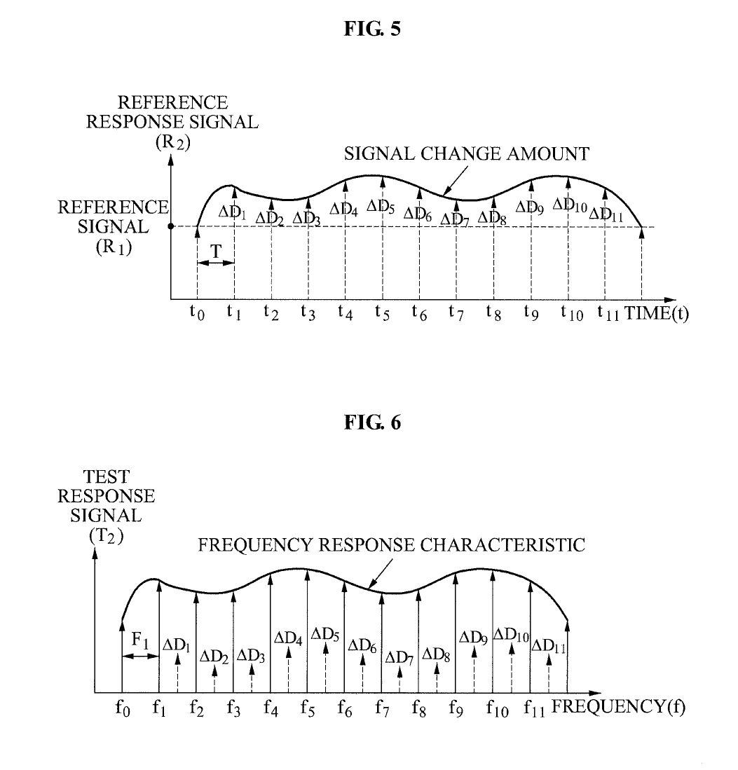

FIG. 5 is a graph showing a signal change amount occurring due to a weather condition according to an embodiment of the present invention.

Referring to the graph of FIG. 5, the signal change amount may be generated by repeatedly generating reference signals R₁ at first time intervals T, transmitting the reference signals R₁ to the satellite transponder 200 in a first time t₀ to a twelfth time t₁₁, receiving a reference response signal R₂ corresponding to each of the reference signals R₁ from the satellite transponder 200, and arranging the reference response signals R₂ with respect to the respective first time t₀ to the twelfth time t₁₁.

A magnitude of the reference signal R₁ that is generated by the satellite performance monitoring system 100 may be consistent at all times. However, a magnitude of the reference response signal R₂ that is generated by the satellite responder 200 may not be consistent at all times. Since the reference response signal R₂ is generated based on the reference signal R₁, the reference response signal R₂ may include even a signal change amount of the reference signal R₁. For example, the reference response signal R₂ may include all of a signal change amount that is an amount of change occurring due to a weather condition while the reference signal R₁ is transmitted from the satellite performance monitoring system 100 to the satellite responder 200, and a signal change amount that is an amount of change occurring due to a weather condition while the reference response signal R₂ is transmitted from the satellite responder 200 to the satellite performance monitoring system 100.

While the test signals T₁ are repeatedly generated at first frequency intervals F₁ as shown in FIG. 3 or FIG. 4, the reference signal R₁ may be added within the first frequency interval F₁ of each test signal T₁ and thereby be transmitted to the satellite responder 200. When the reference response signal R₂ is received from the satellite responder 200, a first signal change amount ΔD₁ to an eleventh signal change amount ΔD₁₁ may be computed. For example, the first signal change amount ΔD₁ to the eleventh signal change amount ΔD₁₁ may be computed by subtracting a corresponding reference signal R₁, that is, an initial reference response signal R₂ (t=0) from the reference response signal R₂.

FIG. 6 is a graph showing a method of applying a reference signal change amount to a frequency response characteristic according to an embodiment of the present invention.

Referring to the graph of FIG. 6, the frequency response characteristic may be generated by repeatedly generating test signals T₁ twelve times at first frequency intervals F₁, transmitting the test signals T₁ to the satellite transponder 200, receiving a test response signal T₂ corresponding to each of the test signals T₁ from the satellite transponder 200, and arranging the test response signals T₂ at first frequency intervals F₁.

Referring to the frequency response characteristic, it is possible to compensate for a change in a signal occurring due to the weather condition by applying the first signal change amount ΔD₁ to the eleventh signal change amount ΔD₁₁ of FIG. 5 to the first frequency interval F₁.

As described above, the first signal change amount ΔD₁ to the eleventh signal change amount ΔD₁₁ may include all of a signal change amount of the reference signal R₁ in an uplink from the satellite performance monitoring system 100 to the satellite transponder 200 and a signal change amount of the reference response signal R₂ in a downlink from the satellite transponder 200 to the satellite performance monitoring system 100. Accordingly, it is possible to compensate for the change in the signal occurring due to the weather condition in the uplink and the downlink by applying the first signal change amount ΔD₁ to the eleventh signal change amount ΔD₁₁ to the frequency response characteristic.

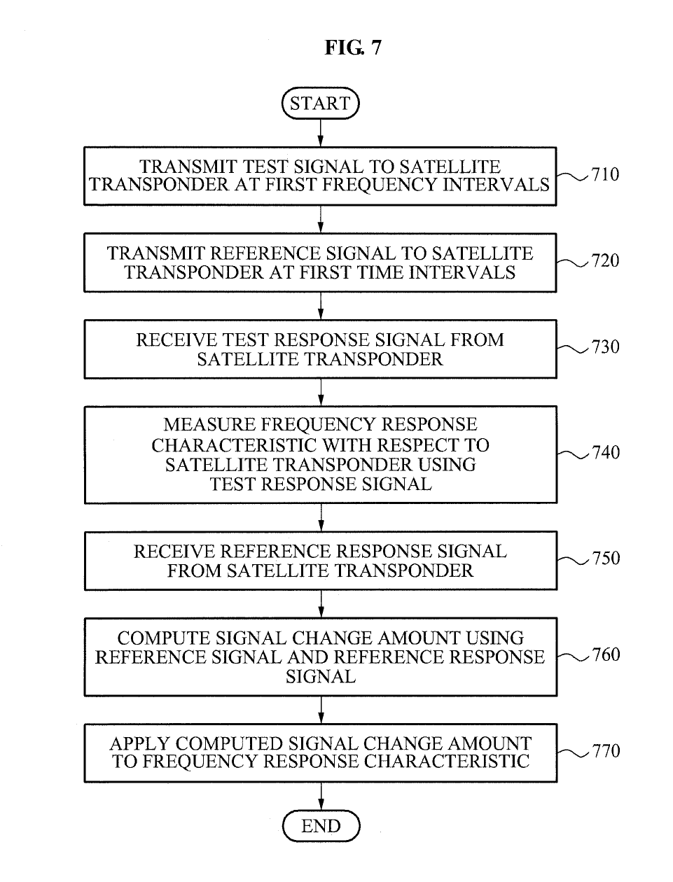

FIG. 7 is a flowchart illustrating a satellite performance monitoring method according to an embodiment of the present invention. The satellite performance monitoring method of FIG. 7 may be performed by the satellite performance monitoring system 100 of FIG. 1 and FIG. 2.

In operation 710, the satellite performance monitoring system 100 may transmit a test signal T₁ for measuring a performance of the satellite transponder 200 to the satellite transponder 200. The satellite performance monitoring system 100 may repeatedly generate the test signal T₁ at first frequency intervals and transmit the test signal T₁.

In operation 720, the satellite performance monitoring system 100 may transmit a reference signal R₁ to the satellite transponder 200. The reference signal R₁ may be used to compute a signal change amount occurring due to a weather change and thus, may be repeatedly generated at first time intervals and thereby be transmitted.

When a test response signal T₂ is received from the satellite transponder 200 in operation 730, the satellite performance monitoring system 100 may generate a frequency response characteristic with respect to the satellite transponder 200 using the test response signal T₂ in operation 740. The satellite performance monitoring system 100 may generate the frequency response characteristic using a graph in which the received test response signals T₂ are arranged at first frequency intervals.

When a reference response signal R₂ is received from the satellite transponder 200 in operation 750, the satellite performance monitoring system 100 may compute a signal change amount occurring due to a weather condition using the reference signal R₁ and the reference response signal R₂ in operation 760. For example, the satellite performance monitoring system 100 may compute the signal change amount by subtracting the reference signal R₁ from the reference response signal R₂.

In operation 770, the satellite performance monitoring system 100 may apply the computed signal change amount to the frequency response characteristic. It is possible to compensate for the frequency response characteristic using a method of adding the computed signal change amount, computed at first time intervals, to the test response signal T₂ that is received at first frequency intervals. Accordingly, regardless of the weather condition, it is possible to accurately measure the performance of the satellite transponder 200 using the compensated frequency response characteristic.

A satellite performance monitoring system and method according to embodiments of the present invention may compute a signal change amount occurring due to a weather condition, using a reference signal and a reference response signal, and may compensate for a frequency response characteristic with respect to a satellite transponder using the computed signal change amount. Accordingly, it is possible to accurately measure the performance of the satellite transponder regardless of the weather condition.

Also, the satellite performance monitoring system may include apparatuses that are installed indoors and outdoors, respectively, and may prevent loss or distortion of signals of Ka band.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A satellite performance monitoring system for measuring a performance of a satellite transponder, the system comprising:
a satellite communication controlling apparatus to transmit a test signal for measuring the performance of the satellite transponder to the satellite transponder and thereby receive a test response signal from the satellite transponder, and to transmit a reference signal to the satellite transponder and thereby receive a reference response signal from the satellite transponder; and
a satellite performance monitoring apparatus to generate the test signal and the to reference signal, to generate a frequency response characteristic with respect to the satellite transponder using the test response signal, to compute a signal change amount occurring due to a weather condition using the reference signal and the reference response signal, and to apply the computed signal change amount to the frequency response characteristic.

2. The system of claim 1, wherein the satellite communication controlling apparatus comprises:
an antenna to transmit and receive a signal to and from the satellite transponder;
a first signal processing unit to process the test signal and the reference signal that are received from the satellite performance monitoring apparatus;
a signal measuring unit to measure a signal characteristic with respect to the test signal and the reference signal; and
a second signal processing unit to process the test response signal and the reference response signal when the test response signal and the reference response signal transmitted from the satellite transponder are received using the antenna.

3. The system of claim 2, wherein the first signal processing unit comprises:
a frequency up-converter to up convert the test signal and the reference signal from L band to Ka band; and
a high power amplifier to amplify the test signal and the reference signal that are up converted to the K band.

4. The system of claim 2, wherein the second signal processing unit comprises:
a low noise amplifier to amplify the test response signal and the reference response signal; and
a frequency down-converter to down convert the amplified test response signal and reference response signal from Ka band to L band.

5. The system of claim 1, wherein the satellite performance monitoring apparatus comprises:
a test signal generator to generate the test signal;
a reference signal generator to generate the reference signal;
a frequency response characteristic generator to generate the frequency response characteristic when the test response signal is received from the satellite communication controlling apparatus;
a signal change amount computing unit to compute the signal change amount by subtracting the reference signal from the reference response signal when the reference response signal is received from the satellite communication controlling apparatus; and
a compensation unit to compensate for a change in a signal occurring due to the weather condition by applying the computed signal change amount to the frequency response characteristic.

6. The system of claim 5, wherein the test signal generator repeatedly generates the test signal at first frequency intervals over the whole channel bandwidth of the satellite transponder.

7. The system of claim 6, wherein the reference signal generator repeatedly generates the reference signal at first time intervals by adding the reference signal within the first frequency interval.

8. The system of claim 5, wherein the reference signal generator adjusts a magnitude of the reference signal to be less than a magnitude of the test signal.

9. A satellite performance monitoring method for measuring a performance of a satellite transponder, the method comprising:
transmitting, to the satellite transponder, a test signal for measuring the performance of the satellite transponder;
transmitting a reference signal to the satellite transponder;
generating a frequency response characteristic with respect to the satellite transponder using a test response signal when the test response signal is received from the satellite transponder;
computing a signal change amount occurring due to a weather condition using the reference signal and a reference response signal when the reference response signal is received from the satellite transponder; and
applying the computed signal change amount to the frequency response characteristic.

10. The method of claim 9, wherein the computing comprises computing the signal change amount by subtracting the reference signal from the reference response signal.

11. The method of claim 9, wherein the transmitting of the test signal comprises:
repeatedly generating the test signal at first frequency intervals over the whole channel bandwidth of the satellite transponder;
up converting the test signal from L band to Ka band; and
amplifying the test signal that is up converted to the Ka band.

12. The method of claim 11, wherein the transmitting of the reference signal comprises:
repeatedly generating the reference signal at first time intervals by adding the reference signal within the first frequency interval;
up converting the reference signal from L band to Ka band; and
amplifying the reference signal that is up converted to the Ka band.

13. The method of claim 9, wherein a magnitude of the reference signal is less than a magnitude of the test signal.

14. A non-transitory computer-readable recording medium storing a program to implement the method of claim 9.
